(19) United States
(12) Patent Application Publication
(10) Pub. No.: US 2007/0017103 A1
(43) Pub. Date: Jan. 25, 2007

(54) Table mount holder for battery powered scissors

(75) Inventors: Michael L. Agronin, Owings Mills, MD (US); Christopher J. Murray, Baltimore, MD (US); DeAnn F. Romjue, Phoenix, MD (US)

Correspondence Address: HARNESS, DICKEY & PIERCE, P.L.C., P.O. BOX 828, BLOOMFIELD HILLS, MI, 48303, US

(73) Assignee: Black & Decker Inc., Newark, DE (US)

(21) Appl. No.: 11/185,903

(22) Filed: Jul. 20, 2005

(51) Int. Cl. B26B 13/00

(52) U.S. Cl. 30/231

(57) ABSTRACT

A tool holder, particularly for holding battery operated scissors, has a base with a mechanism coupled with the base to secure the base to a surface. A holder is coupled with the base. The holder includes a pair of members pivotal with respect to one another between an opened and closed position to receive and release the scissors. A locking mechanism locks the pair of members with respect to one another to lock the scissors between the members.

### FIELD OF THE INVENTION

The present invention relates to tool holders and, more specifically, to a table mount holder for battery powered scissors.

### BACKGROUND AND SUMMARY OF THE INVENTION

Scissors have been utilized for many years in various types of cutting and craft applications. With the advent of powered scissors, cutting patterns and material has become easier. However, the user may need to hold the scissor with one hand, while moving the scissor along the pattern. This arrangement may make it difficult to accurately cut the material. Thus, it is desirable to utilize both hands on the material when moving the material through the powered scissors. While various types of devices exist, which hold powered scissors, they have numerous drawbacks.

U.S. Pat. No. 3,698,087 to Cowdrey et al. illustrates a device to hold a pair of power scissors. However, the user may need to continue to hold a power switch on the scissors with one hand in order to activate the scissors. U.S. Pat. No. 2,324,364 issued to Collins illustrates a mechanism to hold power scissors. Also, U.S. Pat. No. 2,316,486 issued to Park likewise shows a mechanism to hold a pair of power scissors. Collins and Park, like Cowdrey, all require the user to hold the scissors and switch while operating the scissors. Thus, the user is unable to utilize both hands to move the material through the scissors in a “hands free” operation. Accordingly, it would be desirable to have a tool holder which enables the user to have use of both hands while the scissors are operating to feed material through the scissors.

The present invention provides a table mount for holding battery powered scissors that enables “hands free” use by the user. The present invention provides a mechanism which actuates a first trigger switch which enables operation of the scissors by activation of a second switch. The present invention locks the scissors between a pair of pivotal members which secure the scissors in the mount. The scissors are positioned a desired distance above the holder base to prohibit rattling of the scissors against the table mount. The present invention also helps to reduce noise which may be reflected back towards the user during use.

In accordance with a first aspect of the invention, a tool holder comprises a base with a mechanism coupled to the base to secure the base to a surface. A holder is coupled with the base. The holder has a wall defining a bore to receive a tool. An actuating mechanism is coupled with the wall to actuate a switch on the tool. The holder is spaced with respect to the base so that the tool, when it is in the holder, is spaced from the base. The base is perforated to reduce noise. The wall includes a cutout to enable access to a second switch on the tool. The wall has an inner surface which has a contour to complement an outer surface of the tool to enhance securement in the wall.

In accordance with the second aspect of the invention, a tool holder comprises a base with a mechanism coupled with the base to secure the base to a surface. A holder is coupled with the base. The holder includes a pair of members pivotable with respect to one another between an opened and closed position to receive and release the tool. A locking mechanism locks the pair of members with respect to one another to lock the tool between the members. At least one of the pair of the members includes a mechanism to activate a switch on the tool. The pair of members includes an inner surface having a contour complimenting an outer surface of the tool to enhance retention of the tool in the holder. The holder is spaced with respect to the base so that the tool, when in the holder, is spaced above the base. The base includes perforations to reduce noise. Also, the pair of members includes a cutout to enable access to a second switch on the tool. The locking mechanism includes a rail on each of the pair of members and a latch coupled with the rails to slidably engage the rails to lock the member with one another. In an alternate embodiment, the locking mechanism includes a latch and catch on the pair of members to lock the members with one another.

According to a third aspect of the invention, a scissor holder comprises a base with a mechanism coupled to the base to secure the base on a surface. A scissor holder is coupled with the base. The scissor holder includes a pair of members pivotable with respect to one another between an opened and closed position to receive and release the scissors. A locking mechanism locks the pair of members with respect to one another to lock the scissors between the members. At least one of the pair of members includes a mechanism to activate a switch on the scissors. The pair of members includes an inner surface having a contour complementing an outer surface of the scissor to enhance retention of the scissors in the holder. The holder is spaced with respect to the base so that the nips of the scissors, when in the holder, are spaced from the base. The base is perforated to reduce noise. The pair of members includes a cutout to enable access to a second switch on the scissors. The lock mechanism includes a rail on each member and a latch coupled with the rails to slidably engage the rails to lock the scissors between the members.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a tool holder in accordance with the present invention.

FIG. 2 is a perspective view with the holder in an unlocked position.

FIG. 3 is a side elevation view of the holder of FIG. 1.

FIG. 4 is a top plan view of the holder of FIG. 1.

FIG. 5 is an enlarged side view like FIG. 3.

FIG. 6 is an enlarged perspective view of the locking mechanism of FIG. 4.

FIG. 7 is a perspective view of a second embodiment in accordance with the present invention

FIG. 7A is an enlarged perspective view of the locking mechanism of FIG. 7.

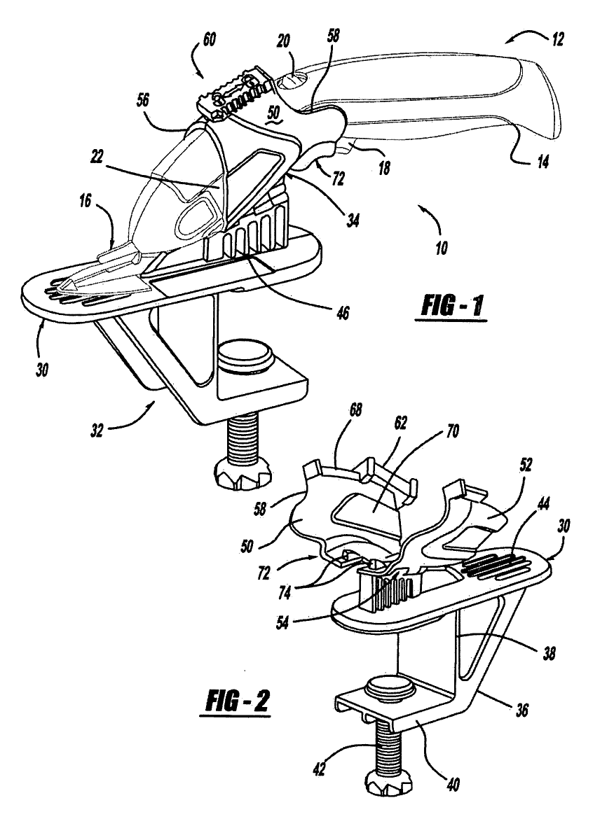

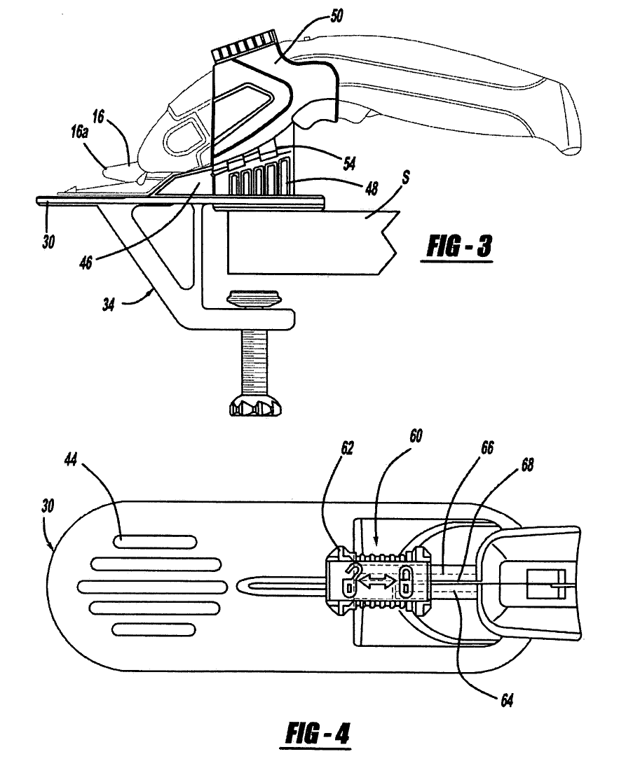

### DETAILED DESCRIPTION OF THE PREFERRED EMBODIMENTS

The following description of the preferred embodiments is merely exemplary in nature and is in no way intended to limit the invention, its application, or uses.

Turning to the figures, a tool holder is illustrated and designated with the reference numeral 10. The tool holder 10 is a table mount to hold battery powered scissors 12. The scissors 12 include a housing 14, which includes a cutting nip or blade 16 at one end of the housing 14. The scissors 12 include a trigger switch 18 and a sliding switch 20 to activate the scissors 12. The sliding switch 20 must be in an on position in order for the trigger switch 18 to activate the cutting nips or blades 16, or vice versa. Also, the outer surface of the housing 14 includes recesses 22 which provide an aesthetic appearance and enhance gripping of the scissors 12 when positioned in the holder 10.

The holder 10 includes a base 30 with a clamp mechanism 32 which retains the holder 10 on a surface. Also, a holder 34 is coupled with the base 30. The clamping member 32 includes an L-shaped member 36 having a first leg 38 attached to the base 30 and a second leg 40 substantially perpendicular to the first leg 38. A thumbscrew 42 is positioned through the leg 40. The thumbscrew 42 is rotated to secure the tool holder 10 onto a surface (S) (FIG. 3). A portion of the base 30 adjacent to the cutting nip 16 may extend beyond an edge of the surface (S).

The base 30 is generally a planar member. The base 30 has a desired configuration and is illustrated as an ellipsis or oval. Ordinarily, the base 30 includes a plurality of apertures 44 which form perforations in the base 30. The perforations 44 enable sound to pass through the base 30 so that sound is not reflected back to the user which, in turn, reduces noise during operation.

The base 30 includes a holder support 46. The holder support 46 extends perpendicular from the base 30. The holder support 46 has a desired height so that, when the scissors 12 are positioned in the holder support 46, the nips 16 of the scissors 12 are positioned and spaced above the base 30 and extend beyond the surface (S). The positioning of the nips or blades 16 above the base 30 reduces rattle and noise. The support 46 includes a plurality of apertures 48. The apertures enhance the strength as well as reduce the noise during operation of the scissors.

In an example, a portion of support 46 may define a riving knife, which may abut the scissors 12. The riving knife may guide material along the base 30 as the scissors 12 cut the material. The riving knife may reduce the propensity of the material to catch (i.e., bunch-up or jam) on the base 30. In another example, the tips 16a of the nips or blades 16 may rounded. The nips or blades 16 may be spaced from one another such that a capacity of the nips 16 is about one-eighth of an inch (about three millimeters). An object, for example, having a dimension (e.g., a diameter) greater than the capacity would not fit between the nips or blades 16.

The tool holder 34 includes a pair of members 50 and 52. The members 50 and 52 are secured to the support 46 via a pivot arrangement 54. Thus, the members 50 and 52 pivot with respect to one another between an open and closed position. This enables the scissors 12 to be positioned between and retained by the members 50 and 52.

The members 50 and 52 are curved so that, when they are coupled with one another, they define a cylindrical wall. The wall defines a bore 56 which extends through the two members 50 and 52. The bore 56 receives the scissors 12. The members 50 and 52, at one end, define a cutout 58 which enables the second scissor switch 20 to project between the two members 50, 52 which enables the switch 20 to be activated by the user.

The members 50 and 52 are held together by a locking mechanism 60. The locking mechanism 60 includes a latch 62 slidably received on rails 64 and 66. The rail 64, on member 50, fits in cutout portion 68 of rail 66. Thus, when the latch 62 is in a locked position, covering the rails 64, 66, the members 50 and 52 are locked together. The latch 62 is moved in one direction uncovering rail 64 which enables member 50 to pivot with respect to member 52. This enables the scissors 12 to be removed from the members 50, 52.

The inner surface of the members 50 and 52 include a contour 70 which fits into the recess 22 on the scissors 12. The contour 70 retains the scissors 12 in position in the holder 34 when the scissors 12 are locked between the members 50, 52.

The members 50 and 52 also include a trigger switch activating mechanism 72. The trigger switch activating mechanism 72 includes a configuration to receive the trigger switch 18. A ramp 74 is positioned on the inner surface of the trigger activation mechanism 72. The ramp 74 contacts the trigger 18 forcing it into an on position. Accordingly, when the scissors 12 are locked into the holder 34, the trigger switch 18 is in an on position. When the sliding switch 20 is moved to an on position, the scissors are activated. At this time, the scissors are securely locked into the holder 34 and the scissors 12 are in the on position. Accordingly, the user has both hands free from the scissors 12 to enable “hands free” use of the scissors 12.

In an example, the switches 18, 20 may be electrically connected in series. The trigger switch 18 includes a momentary switch that needs to be continually pressed to close the switch and if not, the switch remains open. The sliding switch 20 includes a toggle switch, which rests in a position that closes the switch or another position that opens the switch. The sliding switch 20 may be positioned so that the scissors activate when the trigger switch 18 is moved to the on position. The sliding switch 20 may be configured to require more force to the move the sliding switch 20 relative to moving the trigger switch 18.

The tool holder may be manufactured from an injection molding operation. In this case, several of the elements, such as the base 30, the clamping mechanism 32, support 46 and possibly part of the holder 34 may be manufactured as a single plastic piece. The member 50 would then be secured along the pivot mechanism 54 and the lock latch 62 installed onto the rails 64, 66. The scissors 12 may operate with a battery that may be integral with or couple to the scissors 12. The battery may be rechargeable.

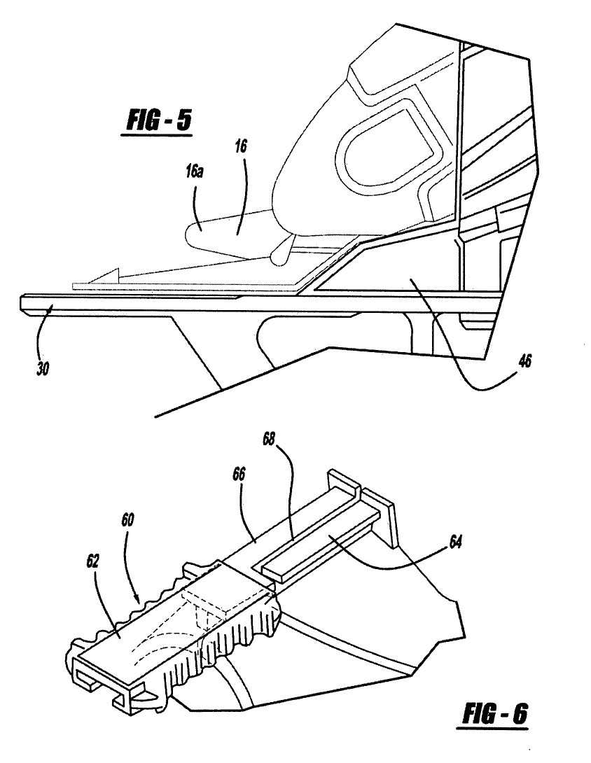

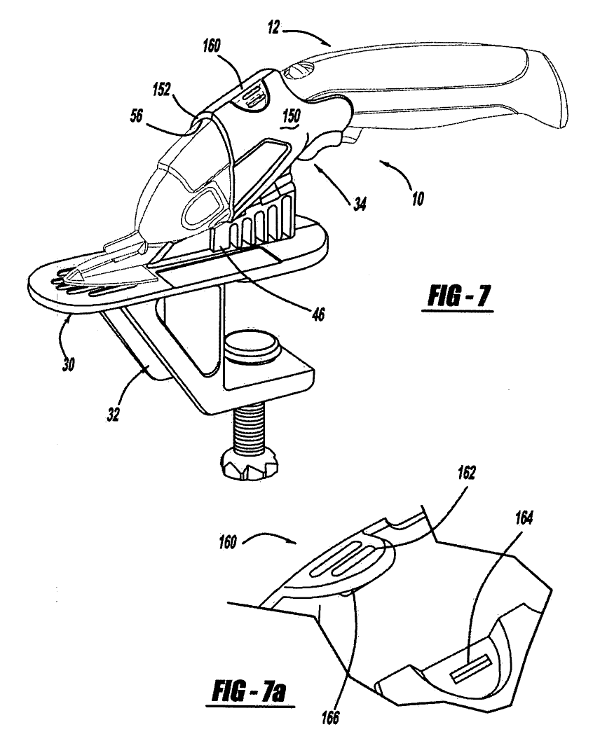

Turning to FIGS. 7 and 7A, a second embodiment is illustrated. In FIGS. 5 and 5A, the elements which are the same will be identified with the same reference numerals. Here, the difference resides in the locking mechanism 160. The members 150 and 152 include a latch 162 and catch 164 mechanism. As the members 150 and 152 are pivoted with respect to one another, the latch 162 with a depending tang 166 is secured in the catch 164. To release the latch 162 from the catch 164, the latch 162 is lifted up and the members 150, 152 are pivoted away from one another. The remainder of the holder mechanism 34 is substantially identical to that which has been previously described.

While the above detailed description provides a description of the preferred embodiment, other objects and advantages of the present invention will become apparent to those skilled in the art.

What is claimed is:

1. A tool holder comprising:
a base;
a mechanism coupled with said base for securing said base to a surface;
a holder coupled with said base, said holder having a wall defining a bore to receive the tool; and
a mechanism coupled with said wall for activating a switch on the tool.

2. The tool holder according to claim 1, wherein said holder being spaced with respect to said base so that the tool, when in said holder, is spaced from the base.

3. The tool holder according to claim 1, wherein said base being perforated for reducing noise.

4. The tool holder according to claim 1, wherein said wall includes a cutout for enabling access to a second switch on the tool.

5. The tool holder according to claim 1, wherein said wall has an inner surface having a design to complement an outer surface of the tool for enhancing retention of the tool in the wall.

6. A tool holder comprising:
a base;
a mechanism coupled with said base for securing said base to a surface;
a holder coupled with said base, said holder including a pair of members pivotable with respect to one another between an open and a closed position for receiving and releasing a tool; and
a locking mechanism for locking said pair of members with respect to one another to lock the tool between the members.

7. The tool holder according to claim 6, further comprising at least one of said pair of members including a mechanism for activating a switch on the tool.

8. The tool holder according to claim 6, wherein said pair of members include an inner surface having a design complementing an outer surface of the tool for enhancing retention of the tool in the holder.

9. The tool holder according to claim 6, further comprising a support between said holder, spacing said holder from said base.

10. The tool holder according to claim 9, wherein a portion of said support defines a riving knife.

11. The tool holder according to claim 6, wherein said pair of members includes a cutout for enabling access to a second switch on the tool.

12. The tool holder according to claim 6, wherein said lock mechanism includes a rail on each member and a latch coupled with said rails for slidably engaging said rails for locking the member with one another.

13. The tool holder according to claim 6, wherein said locking mechanism includes a latch and a catch on said pair of members for locking the member with one another.

14. A scissor holder comprising:
a base;
a mechanism coupled with said base for securing said base to a surface;
a holder coupled with said base, said holder including a pair of members pivotable with respect to one another between an open and a closed position for receiving and releasing scissors; and
a locking mechanism for locking said pair of members with respect to one another to lock the scissors between the members.

15. The scissor holder according to claim 14, further comprising at least one of said pair of members including a mechanism for activating a switch on the scissors.

16. The scissor holder according to claim 14, wherein said pair of members include an inner surface having a design complementing an outer surface of the scissors for enhancing retention of the scissors in the holder.

17. The scissor holder according to claim 14, wherein said holder being spaced with respect to said base so that the scissors, when in said holder, are spaced from the base.

18. The scissor holder according to claim 14, wherein said base being perforated for reducing noise.

19. The scissor holder according to claim 14, wherein said pair of members includes a cutout for enabling access to a second switch on the scissors.

20. The scissor holder according to claim 14, wherein said lock mechanism includes a rail on each member and a latch coupled with said rails for slidably engaging said rails for locking said members to one another.

21. The scissor hold according to claim 14 wherein a portion of said base adjacent a cutting nip extends beyond an edge of said surface.
